(19) United States
(12) Patent Application Publication
(10) Pub. No.: US 2005/0060339 A1
(43) Pub. Date: Mar. 17, 2005

(54) Method to enable Heartbeat 911

(75) Inventor: Steven James McGee, Oceanport, NJ (US)

Correspondence Address: STEVEN JAMES MCGEE, 82 SEA GIFT AVENUE, OCEANPORT, NJ, 07757, US

(73) Assignee: SAW CONCEPTS LLC, Oceanport, NJ (US)

(21) Appl. No.: 10/709,358

(22) Filed: Apr. 29, 2004

Related U.S. Application Data
(63) Continuation of application No. 10/708,000, filed on Jan. 30, 2004.
(63) Continuation of application No. 10/605,144, filed on Sep. 11, 2003.

(51) Int. Cl. G06F 7/00

(52) U.S. Cl. 707/102; 340/531; 370/254; 370/259; 709/249; 709/250

(57) ABSTRACT

Data elements denoting military and federal systems, platforms and units symbolically as derived from structured military message codes (field unit identifiers, field unit designators) that correlate directly to geospatial symbology as processed by commercial forms engines with underlying message parsing processes provide the capability to display situational understanding information/symbols (1) vice a geographic area of interest shown as basic geometric shapes as in the Common Alert Protocol CAP final release dated 1 Apr. 2004. TCP/IP's universally available heartbeat mechanisms provide a common and consistent send to/get from plus timing/trigger functions for data harvesting and distribution (2). Modifying the CAP or creating child domain specific schemas provide the basis of a international 911 service available on a subscription basis say to neighborhood watch programs and the like that are equipped with GPS smart phones, handhelds, laptops and like devices (3). See attached diagram depicting as a whole, SAW Concepts previous two method patent applications (1), (2) with this application (3) entitled Heartbeat 911.

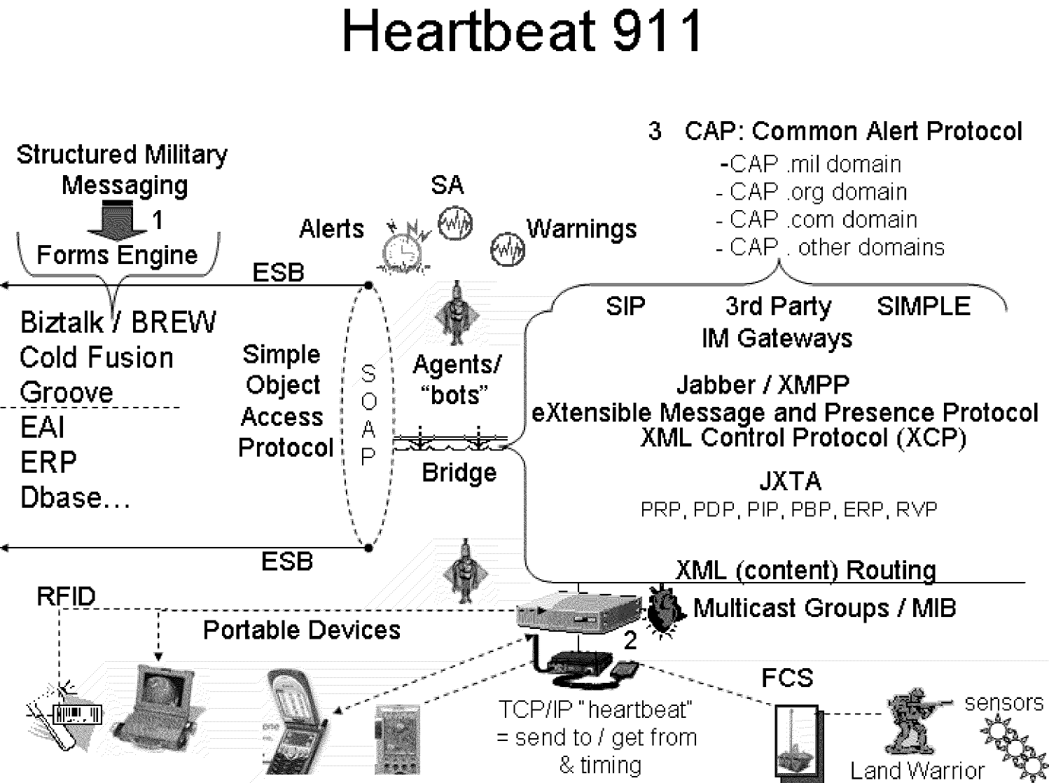

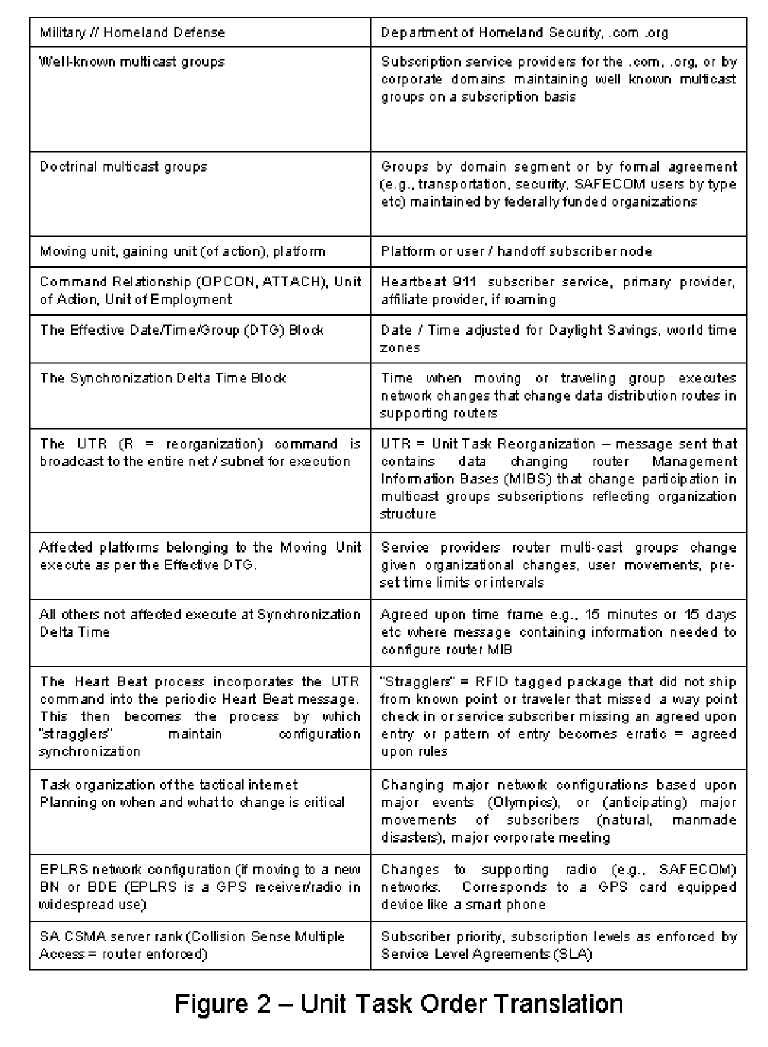

### CROSS REFERENCE TO RELATED APPLICATIONS

Utility Patent Filing, application Ser. No. 10/605,144, EFS ID 47552, date time group (DTG) 2003-09-11 10:55:59 EDT entitled “method to commercialize structured military messaging” by Steven J McGee as shown by the number one (1) in the attached diagram named Heartbeat 911. Utility Patent Filing, application Ser. No. 10/708,000, EFS ID 54568, date time group 2004-01-30 20:06:41 EDT entitled “Method to enable a Homeland Security Heartbeat” as shown as number two (2) in the attached diagram entitled Heartbeat 911. This continuation method application is referred to throughout this application as (3).

### FEDERAL RESEARCH STATEMENT

Updating SAW Concepts first (1) method patent application and the continuation (2) cited in the cross reference section, the Department of Defense (DOD) is now moving towards a “normalized”set/library of common XML schemas replacing structured military message formats since the initial patent method was submitted. SAW Concepts LLC's believes that it helped raise the issue of structured military messaging and its drag on the DOD's “transformation”to the Joint Chiefs of Staff level as a relevant aside. However, SAW Concepts has yet to see posted plans or contracts requesting/requiring that these XML schemas libraries or message sets be imported into commercial forms engines supported by underlying message engines/parsers such as Groove Network's Groove or Microsoft's InfoPath/Biztalk or Jabber's (XMPP-eXtensible Messaging and Presence Protocol based) framework (1). SAW Concepts cites the Army's Research Development and Engineering Center's (RDEC) 2003 year's projected improvements for 2004 and beyond e.g., the Army RDEC's proposed “Situation Server for the JBFSA” Joint Blue Force Situational Awareness plans to illustrate that it plans on providing its own messaging mechanisms vice implementing a total Commercial Off the Shelf (COTS) technology approach—documentation available upon request In context with SAW Concept's continuation method to “enable a homeland security heartbeat”, in monitoring various DOD and DHS portals, magazines that cover federal activity and contract announcements, SAW Concepts has noted that House Democrats on the Homeland Security committee's statement “nothing less than network centric homeland security akin to network centric warfare” See: http://www.gcn.com/vol1_no1/daily-updates/25249-1.ht ml, but has yet to observe where plans/announcements/contractual requirements stipulate that the TCP/IP heartbeat primitives and timing mechanism will be used as the basis of a universal data harvesting, timing and trigger mechanism supporting a ubiquitous homeland security heartbeat or “Heartbeat 911” (3). Steven J McGee/SAW Concepts LLC provided a summary of its patent applications to the Science and Technology Directorate of the DHS in the January 2004 timeframe which responded by advising that SAW Concepts submit an unsolicited proposal given that the DHS had “not enough information” and “no such plans or requirements (to implement a Homeland Security heartbeat) at this time”. More visibly, in the recently released Common Alert Protocol (CAP) standard see: http://www.incident.com/cap/docs/CAP_{—}1.0/oasis-2004 02-cap-core-1.0.pdf dated 10 Feb. 2004; SAW Concepts asserts that the CAP (an XML schema) was constructed with federal, state and local entities in mind but not how the military is structured, organized and how it operates an aspect that needs addressed either by developing a child .mil (.com, .org) domain CAP schema or by reworking the CAP schema altogether the former being more likely than the latter (3). Note that this CAP schema does not mention TCP/IP's heartbeat mechanism or how the military leverages the heartbeat mechanisms to support a universal data gathering/timing trigger as a critical case in point (2). The Common Alert Protocol (CAP) was designed to be transport agnostic. CAP as described as: “a standard method should be developed to collect and relay instantaneously and automatically all types of hazard warnings and reports locally, regionally and nationally for input into a wide variety of dissemination systems.” See: http://www.incident.com/cap/index.html and as “The Common Alerting Protocol will enhance government's “situational awareness” at the state, regional and national levels by providing a continual real-time database of all warnings, even local ones.” Related to the CAP, the document” An Advanced EAS Relay Network Using the Common Alerting Protocol (CAP) by Art Botterell see: www.incident.com/cap/docs/aps/Advanced_EAS_Concept. pdf. This document cites TCP/IP as a transport but does not cite TCP/IP's heartbeat primitives as a universal means to send to, get from and time-trigger the frequency of data exchanges—regardless of commercial product, approach and maintaining backwards compatibility and consistency with current DOD Blue Force Tracking (BFT) mechanisms (2). Also, the CAP has provisions for describing geographical areas of interest as geometric shapes but does not currently resolve to ten digit GPS derived grid coordinates that are associated with individual vehicles, platforms or users like the military's systems (1, 3).]

### BACKGROUND OF INVENTION

The nature of this continuation is that of a use case best represented by the attached drawing that is numbered 1, 2, 3 that denotes the base, 1 st, 2 nd and this (3 rd) method patent continuation. Collectively, the three method patent applications describe facets where the military or Government Off the Shelf (GOTS) attributes of the DOD's “killer application” (Force XXI Battle Command Brigade and Below-FBCB2/Blue Force Tracking-BFT) are modified for commercial use via COTS that in turn should influence the design of the 1 Apr. 2004 released Common Alert Protocol as nested structures within the overall CAP schema or alternately and more likely, through the creation of child schemas corresponding to domains of interest (.mil, .org etc). SAW Concepts is basing this continuation method patent application on predicting that the CAP as an XML schema and the DOD's “normalization” or unification of its many structured military messaging formats into a single XML schema repository work will occur in time (basis of this method patent continuation and shown by a 3 in the diagram) and that when this work is completed, the military's use of the universal TCP/IP “heartbeat” mechanisms (basis of method patent continuation and shown as a 2 in the diagram) will be adopted universally to enable a “heartbeat 911” capability. In this way, the DHS can work with the DOD to ensure cross domain interoperability, commonality and speed the implementation process for a capability needed now—not five or six years from now or never.

### SUMMARY OF INVENTION

Principle Operation of the Invention: data elements derived from structured military messaging as processed by commercial forms engines with underlying message parsing processes provide the ability to resolve down to the individual platform level symbolically vice a geographic area of interest as in the CAP (1, 3). TCP/IP's heartbeat mechanisms provide a common and consistent send to /get from plus timing/trigger function for data harvesting and exchanges (2) while modifying the CAP or creating child domain specific schemas can provide the basis of a international Heartbeat 911 service available on a subscription basis say to neighborhood watch programs and the like (3) that are equipped with GPS smart phones, handhelds, laptops and like devices.

### BRIEF DESCRIPTION OF DRAWINGS

Describing the first diagram named “Heartbeat 911”, the radio icon as connected to the router icon with the heart icon adjacent to it (see the number 1) is the focal point of this diagram and is a simple topology of the military's so called “lower tactical internet” environment. Everything above the router icon and line serves to show the myriad options available to disseminate “situational awareness SA” related data. This is the main reason why a universal and relatively simple set of mechanisms to harvest, time and trigger the dissemination of SA that is consistent and backwards compatible with current deployed military systems yet interoperable with commercial stakeholders (e.g., high value targets) is needed. This application's federal research statement cites Army last years (2003) plans. Given the reliance on structured military messaging, in the Army's own words “for small target platforms, such as a handheld computer, no known options are available”. By applying SAW Concepts series of method patents, this condition could be addressed. By applying SAW Concepts recommendations, regardless of the approach described above the router icon, a means to harvest data could be made available not only to the Army to address its shortfalls in capabilities for our soldiers but a corporate friendly, universally applicable means can be provided in the defense of our homeland. The military is moving towards the elimination of its structured military message formats (e.g., JVMF, USMTF, TADILS as described by previous submissions) but it needs encouragement to be more open to commercially available software products that incorporate both forms engines and message parsers. The bottom right hand corner of the diagram shows Future Combat System (FCS) and Land Warrior that are radio supported environments that rely on Blue Force Tracking software. Blue Force Tracking software regards platforms or users that have been separated from their teams or groups as “stragglers”. SAW Concepts is asserting in this application that this notion of “stragglers” would suit the commercial/Homeland Security domains by treating say high profile users or RFID tracked packages that inexplicably stray from their itineraries/routines as “stragglers”. Stragglers on a Blue Force Tracking screen are shown as dimmed or grayed out icons as “stale” in other words, their reporting has become erratic or infrequent enough to be considered out of date. Stragglers are considered to be out of synchronization with router MIBs in the lower TI as an example. When the Common Alert Protocol (CAP) is reworked or when child domain CAP schemas are developed (see number 3 in the upper right hand corner of the diagram), the “straggler” convention and supporting business logic can be modified at the application layer in the respective domains. To finish describing this diagram, taking the citing of the Cold Fusion application in the left center of the diagram as an example, Cold Fusion does not need to leverage TCP/IP's heartbeat primitives to get from/sent to or time data transactions but Cold Fusion tags can be developed to work to trigger and receive the harvest data generated by TCP/IP's heartbeat mechanisms. Point being, if the military/Department of Homeland Security/Commercial stakeholders are to rapidly implement a cross domain, consistent, interoperable solution any time soon, SAW Concepts believes that the universally available and relatively simple TCP/IP heartbeat mechanisms are the single best approach to achieve a cross domain defense strategy. Situational Awareness could be made available to commercial subscribers given encrypted XML payloads delivered by Jabber/XMPP protocols through third party gateways to most major Instant Messaging services as an example, thus enabling more efficient neighborhood watch programs or corporate means to protect its employees while in transit or to spot derivations in habitual habits, operations, routines or tendencies that may indicated duress. As the military's UTO heartbeat mechanism (a human operator of a management work station located near or with the router) sends new minor number UTO message(s)—periodically at a time after a UTO effective date time group (DTG) via radio net or sub net wide well-known multicast groups using field order messages that could be CAP child schemas on the commercial/DHS side; users will be notified via “pop-up” window or alert mechanisms (TBD) if UTO changes should be executed. If no action is taken by the operator or if the tracked platform/smart-phone or other GPS equipped device (laptop) does not report in after so many UTO reporting cycles, then the subscriber node servicing this user spawns a request for emergency assistance (heartbeat 911 distress alert) to the Terrorist Threat Integration Center (TTIC) for processing onward distribution through military or DHS distribution channels or both as the business logic/mission thread dictates (e.g., automatically or requires operator action)—recalling the description of the “straggler” notion. Heartbeat 911 service subscribers could manually select symbols to represent the potential threat and or send short text messages as an active response measure, neighborhood watch mechanism, and organizational security program.

The second diagram named UTO Translation is a self describing word table converted to a graphic where the military's Unit Task Order that is used to organize, reorganize for battle by sending information gathered by the heartbeat mechanism (send to, get from, timing) to the “tactical CIO” or S-6 who prepares a message that carries data to update the tactical router MIBS or management information dbase that in turn change network settings and the critical multicast groups. This diagram simply translates the military jargon on the left to more commercial mainstream terms on the right.

### DETAILED DESCRIPTION

The nature of this continuation is that of a use case best represented by the attached drawing that is numbered 1, 2, 3 that denotes the base, 1 st, 2 nd and this (3 rd) method patent continuation. Collectively, the three method patent applications describe facets where the military or Government Off the Shelf (GOTS) attributes of the DOD's “killer application” (Force XXI Battle Command Brigade and Below-FBCB2/Blue Force Tracking-BFT) are modified for commercial use via COTS that in turn should influence the design of the 1 Apr. 2004 released Common Alert Protocol as nested structures within the overall CAP schema or alternately and more likely, through the creation of child schemas corresponding to domains of interest (.mil, .org etc). SAW Concepts is basing this continuation method patent application on predicting that the CAP as an XML schema and the DOD's “normalization” or unification of its many structured military messaging formats into a single XML schema repository work will occur in time (basis of this method patent continuation and shown by a 3 in the diagram) and that when this work is completed, the military's use of the universal TCP/IP “heartbeat” mechanisms (basis of method patent continuation and shown as a 2 in the diagram) will be adopted universally to enable a “Heartbeat 911” capability. In this way, the DHS can work with the DOD to ensure cross domain interoperability, commonality and speed the implementation process for a capability needed now—not five or six years from now or never. Use of TCP/IP's heartbeat mechanisms as the basis for setting up the network (router and router Management Information (data) base (MIB)) preconditions, maintenance and change agents to exchange situational awareness information (where am 1, where are my friends, where is the threat, what, when, how fast, how often etc) is extremely well documented by the DOD and is at the “heart” of this application. The established base of expertise throughout the armed forces should be leveraged in the defense of our homeland. Key is that this DOD technology (Blue Force Tracking or BFT) accounts for “stragglers” that denote weapons platforms, vehicles, or tanks etc that for whatever reason have re-affiliated or tethered elsewhere on the network (captured, destroyed, in maintenance) that could be applied on the DHS/commercial side of the equation as tracking high value targets (corporate CEO's, diplomats) as a service and security measure (3). Stated a different way, reinvention of the wheel is not necessary or the best, fastest approach in SAW Concepts opinion. Structured military messaging provides the ability to resolve down to the individual platform level vice a geographic area of interest as in the CAP (1,3), TCP/IP heartbeat mechanisms provide a common and consistent send to and get from plus timing/trigger function (2) while modifying the CAP or creating child domain specific schemas can provide the basis of a international 911 service available on a subscription basis say to neighborhood watch programs and the like (3). The “killer application of the DOD” (FBCB2 and Blue Force Tracking) applies the Unit Task Order UTO—a hierarchical depiction of unit structure showing how units are organized for operations much like corporate wiring diagrams. The UTO's distribution is driven by the grouping of TCP/IP's “heartbeat mechanisms” described in prior (2) method patent applications (sent to, get from and timer/trigger). SAW Concepts LLC is suggesting to the Federal Government by way of this method patent continuation application; that as structured military messaging gives way to XML schema/messages processed by commercial forms engines (1) that the TCP/IP “heartbeat” mechanisms (2) be used for a Homeland Security/Defense “heartbeat 911” service or “engine” (3). The basis of this heartbeat 911 service (3) is either the Common Alert Protocol schema updated to stipulate use of TCP/IP's heartbeat mechanisms, the military's use of structured military messaging to link GPS data with platform type and frequency etc (1,3) to fulfill the CAP protocol's stated goal to provide “a standard method to collect and relay instantaneously and automatically all types of hazard warnings and reports locally, regionally and nationally for input into a wide variety of dissemination systems” in a manner that is backwards compatible with current FBCB2/Blue Force Tracking equipped units. If the CAP is not updated or modified then sub domain CAP schema's (.mil, .com, .org) domains can be designed to leverage the military's structured military messaging logic (1), mechanisms and application of the universal TCP/IP heartbeat mechanisms (2) in those domains to form the basis of “heartbeat 911” (3). Stated another way for clarification, SAW Concepts LLC is advocating the merger of the best of both worlds e.g., the intent behind the military's structured military messaging (it is a form of electronic commerce/data interchange in low bandwidth environments), the rational behind its use of the TCP/IP heartbeat (simple, efficient, repeatable, consistent) with the intentions behind the development of the Common Alert Protocol CAP (3). The DOD's “killer application” Blue Force Tracking software regards platforms or users that have been separated from their teams or groups that are delinquent in reporting or that have not received updated network configuration status (Unit Task Order or UTO data) as “stragglers”. SAW Concepts is asserting that this notion of “stragglers” could suit commercial/Homeland Security domains by treating organizations, units or high profile users or even RFID tracked packages that stray from posted itineraries or routines as “stragglers” Stragglers on a Blue Force Tracking screen are shown as dimmed or grayed out icons as “stale”. When the Common Alert Protocol (CAP) is reworked by adding nested XML schema elements or when derivative child domain CAP schemas are developed (more likely); the merging the intent behind structured military messaging as driven by the TCP/IP heartbeat process can be combined with a unified CAP structure or child structures to achieve a universal military/commercial, JIM (Joint Interagency, Multinational) domain “Heartbeat 911” service. Supporting this continuation method applications are the previous continuation and base claims that collectively form the basis of a DHS, commercial, organizational “heartbeat 911” service.

1. A method of claim whereas the Common Alert Protocol CAP equivalent of the Army's Unit Task Order-UTO heartbeat (field order) message that enables FBCB2-BFT equipped platforms to receive current “active” data reflecting the who, what, where, when, how often at a later time if these platforms of interest (GPS equipped handheld, laptop or smart-phones) were out of radio range, turned off, or down for maintenance or in a duress condition at the time of initial transmission serves as the basis of a national or international “heartbeat 911” service (3). The commercial equivalent CAP message may be part of the CAP XML schema that is modified or as a child XML schema corresponding to the domain of interest (.mil, .org, .com, other).

2. A method of claim whereas the Unit Task Order-UTO command identifies on the military side of the equation shown by the left hand table section and the commercial /DHS equivalent or translations on the right side of the table located in the figure section as UTOtranslation. The claim is that the UTO's intent, functionality could be applied in the DHS-commercial, organizational domains as either nested structures in a modified CAP schema or as child CAP schemas to meet both military and DHS goals. The table in the figures section titled UTOtranslation provides a means to convey the main functions of the Unit Task Order.

3. Method of claim: Development of a nested CAP schema element or derivative child schema represented as the number 3 in the included heartbeat 911 diagram—that enables the following described functionality: RFID Radio Frequency Identification where RFID tags if the active type, sends data to a network monitoring/relay that in turn sends the date time stamp, service provider or organization data, GPS derived location etc as harvested by the TCP/IP primitive heartbeat mechanisms (2) to a threat integration center via router/switches (SAFECOM/HISN) applying the principles behind Blue Force Tracking (BFT) (e.g., filtering applying business rules (mission thread logic in military speak) and FBCB2 as described in this patent and previous patent applications. The application layer performs the requisite association of the three and four digit codes that correspond to symbology derived from message data elements that correspond to geospatial symbols applied by geospatial applications such as ESRI Corporation as an example. The result of this method is that RFID tagged packages, devices or even humans wearing RFID tagged bracelets can automatically generate situational awareness data that is granular to ten digit GPS location data and individual platforms and equipment vice general geometric areas of interest and non-GPS derived location data characteristic of the CAP final release.
